(19) United States
(12) Patent Application Publication
(10) Pub. No.: US 2011/0167795 A1
(43) Pub. Date: Jul. 14, 2011

(54) NANOTHERMITE THRUSTERS WITH A NANOTHERMITE PROPELLANT

(75) Inventors: Shubhra Gangopadhyay, Columbia, MO (US); Steve Apperson, Columbia, MO (US); Keshab Gangopadhyay, Columbia, MO (US); Rajagopalan Thiruvengadathan, Columbia, MO (US); Andrey Bezmelnitsyn, Columbia, MO (US)

(73) Assignee: CURATORS OF THE UNIVERSITY OF MISSOURI, Columbia, MO (US)

(21) Appl. No.: 12/763,809

(22) Filed: Apr. 20, 2010

Related U.S. Application Data
(60) Provisional application No. 61/217,833, filed on Jun. 5, 2009.

(51) Int. Cl. F02K 9/00

(52) U.S. Cl. 60/254

(57) ABSTRACT

In various embodiments, the present disclosure provides a thruster that utilizes a nanothermite material as a propellant. The thruster generally includes a body having at least one sidewall and a bottom wall that define a propellant chamber having a closed repulsion end and an opposing open exhaust end. The thruster additionally includes a nanothermite propellant configured within the propellant chamber to have a selected density that dictates a reaction propagation rate of the nanothermite propellant such that the reaction propagation rate will have a selected one of two distinctly different force-time profiles.

### CROSS-REFERENCE TO RELATED APPLICATIONS

This application claims the benefit of U.S. Provisional Application No. 61/217,833, filed on Jun. 5, 2009. The disclosure of the above application is incorporated herein by reference in its entirety.

### GOVERNMENT RIGHTS

This invention was developed in the course of work under U.S. Government Army Contract DAAE30-01-9-0800-0082. The U.S. government may possess certain rights in the invention.

### FIELD

The present disclosure relates to thrusters, and more particularly to thrusters that utilize nanothermite materials as a propellant.

### BACKGROUND

The statements in this section merely provide background information related to the present disclosure and may not constitute prior art.

Solid-propellant thrusters are thrusters that use the chemical reaction of a solid propellant to produce thrust force. In general, solid chemical thrusters consist of a chamber for housing the solid propellant, a suitable ignition triggering mechanism (e.g. electric heater in contact with the propellant), and in many cases a nozzle for enhancing the thrust force. Thruster performance is described by parameters such as the amplitude of the thrust force (measured in Newtons), duration of thrust, total impulse (integral of the force-time profile) and specific impulse, i.e., total impulse divided by propellant weight, among other.

The use of very small thrusters, e.g., microthrusters or minithrusters having a cross-sectional area of less than 1 cm², has been considered for applications such as modification of projectile trajectory or micro/nanosatellite position. For example, lateral guidance of spin-stabilized projectiles requires a short duration thrust to avoid rotation of the thrust vector as the projectile spins. Considering a projectile rotating at greater than 200 Hz, a thrust duration of 0.4 ms would correspond to a projectile rotation of approximately 29°. Accordingly, for such applications, a thruster fuel should be optimized to have the shortest possible combustion duration, e.g., less than 0.1 ms, to minimize rotation of the thrust vector during actuation. Additionally, the reaction pressure of the propellant must be low enough so as to not damage the thruster and/or the object to which the thruster is attached, while conversely being high enough to provide the desired total impulse.

### SUMMARY

In various embodiments, the present disclosure provides a thruster that utilizes a nanothermite material as a propellant. The thruster generally includes a body having at least one sidewall and a bottom wall that define a propellant chamber having a closed repulsion end and an opposing open exhaust end. The thruster additionally includes a nanothermite propellant configured within the propellant chamber to have a selected density that dictates a reaction propagation rate of the nanothermite propellant such that the thrust impulse will have a selected one of two distinctly different force-time profiles.

In various other embodiments, the present disclosure provides a method for controlling a force-time profile of a thrust impulse. Generally, the method includes disposing a nanothermite propellant within a propellant chamber of a body of a thruster. The body includes at least one sidewall and a bottom wall that define the propellant chamber, wherein the propellant chamber has a closed repulsion end and an opposing open exhaust end. The method additionally includes configuring the nanothermite propellant within the propellant chamber to have a density selected to be either above or below a threshold density at which the reaction propagation rate of the nanothermite propellant changes between a slow characteristic and a fast characteristic. The characteristic reaction propagation rate of the nanothermite propellant, e.g., slow or fast, will affect the force-time profile of the impulse produced by the thruster. Therefore, the reaction propagation rate of the nanothermite propellant is selected such that the thrust impulse has a slow force-time profile or a fast force-time profile based on whether the nanothermite density is selected to be above or below the threshold density.

In yet other various embodiments, the present disclosure provides a thruster that utilizes a nanothermite material as a propellant. The thruster includes a body having at least one sidewall and a bottom wall that define a propellant chamber having a closed repulsion end and an opposing open exhaust end. The thruster additionally includes a nanothermite propellant configured within the propellant chamber to have a density selected to be either above or below a threshold density at which the reaction propagation rate of the nanothermite propellant changes between a slow characteristic and a fast characteristic. Therefore, the reaction propagation rate of the nanothermite propellant is selected such that the thrust impulse has one of a slow force-time profile or a fast force-time profile based on whether the nanothermite density is selected to be above or below the threshold density. The slow force-time profile can be substantially constant for all nanothermite densities above the threshold density and comprises a thrust duration component (Dₛ) and a thrust force component (Fₛ), and the fast force-time profile is substantially constant for all nanothermite densities below the threshold density and comprises a thrust duration component (D_{f}) and a thrust force component (F_{f}), wherein Dₛ is greater than D_{f} and Fₛ is less than F_{f}.

Further areas of applicability of the present teachings will be apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1A is cross-sectional side view of a thruster without a nozzle having a nanothermite material as a propellant, in accordance with various embodiments of the present disclosure.

FIG. 1B is cross-sectional side view of the thruster shown in FIG. 1A having a convergent-divergent nozzle, in accordance with various embodiments of the present disclosure.

FIG. 2 is an exemplary graphical representation of various force-time profiles of a nanothermite thruster when the nanothermite is configured to various densities within a propellant chamber of the thruster shown in FIG. 1A or 1B, in accordance with various embodiments of the present disclosure.

FIG. 3A is an exemplary graphical representation of various force-time profiles of a thruster containing a copper oxide and aluminum (CuO/Al) nanothermite configured to various densities within the propellant chamber of the thruster shown in FIG. 1A, in accordance with various embodiments of the present disclosure.

FIG. 3B is an exemplary graphical representation of various force-time profiles of a thruster containing a bismuth oxide and aluminum (Bi₂O₃/Al) nanothermite configured to various densities within the propellant chamber of the thruster shown in FIG. 1A, in accordance with various embodiments of the present disclosure.

FIG. 4 is an exemplary graphical representation of a force-time profile of the thruster shown in FIG. 1A having a plurality of layers of CuO/Al and Bi₂O₃/Al nanothermite propellant disposed within the propellant chamber, in accordance with various embodiments of the present disclosure. The force-time profiles of thrusters homogeneously loaded with CuO/Al or Bi₂O₃/Al is also shown in order to relate the thrust amplitude of the thruster loaded with a plurality of layers with the thrust amplitude of homogeneously loaded thrusters.

FIG. 5 is an exemplary graphical representation of percentage of theoretical maximum density (TMD) versus packing pressure of a nanothermite propellant disposed within the propellant chamber of a thruster, such as the thruster shown in FIG. 1A, in accordance with various embodiments of the present disclosure.

FIG. 6 is an exemplary graphical representation of the total impulse of the thrust and nanothermite propellant mass vs. packing pressure for a thruster, such as the thruster shown in FIG. 1A, in accordance with various embodiments of the present disclosure.

FIG. 7 is an exemplary graphical representation of the specific impulse of the thrust vs. percentage of TMD for a thruster, such as the thruster shown in FIG. 1A, in accordance with various embodiments of the present disclosure.

FIG. 8 is an exemplary graphical representation of the peak thrust impulse duration and specific impulse versus percentage of TMD of the nanothermite propellant for a thruster, such as the thruster shown in FIG. 1A, in accordance with various embodiments of the present disclosure.

FIG. 9 is an exemplary graphical illustration of various fast force-time profiles for thrusters, such as the thruster shown in FIG. 1A, having various propellant chamber lengths, in accordance with various embodiments of the present disclosure.

FIG. 10 is an exemplary graphical illustration of various slow force-time profiles for thrusters, such as the thruster shown in FIG. 1A, having various propellant chamber lengths, in accordance with various embodiments of the present disclosure.

FIG. 11 is an exemplary graphical illustration of the force-time profile for a thruster having convergent-divergent nozzle, as shown in FIG. 1B, compared with a thruster having no nozzle, as shown in FIG. 1A, wherein the reaction propagation behavior is within a fast regime, in accordance with various embodiments of the present disclosure.

FIG. 12 is an exemplary graphical illustration of the force-time profile for a thruster having convergent-divergent nozzle, as shown in FIG. 1B, compared with a thruster having no nozzle, as shown in FIG. 1A, wherein the reaction propagation behavior is within a slow regime, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

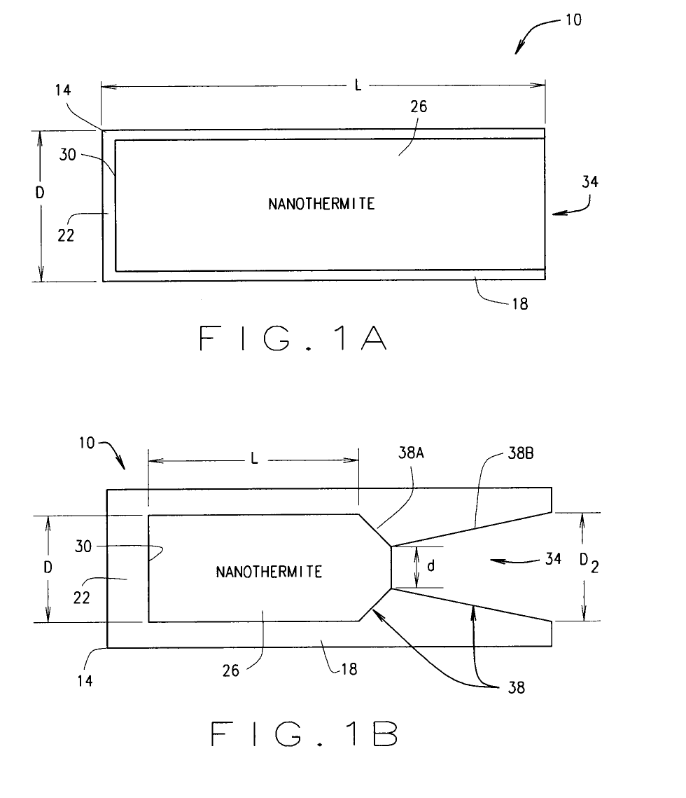

Referring to FIG. 1, in various embodiments, the present disclosure provides a thruster 10 that utilizes a nanothermite material as a propellant. The thruster 10 can be any appropriately sized thruster such as a microthruster or mini-thruster (e.g., a thruster having a cross-sectional area that is less than 1 cm²), or larger thrusters. The thruster 10 can be attached, or mounted, to any suitable object such that upon activation of the thruster 10, i.e., combustion of the nanothermite, the thruster will apply a desired amount of force to the object for a desired duration. For example, in various embodiments, the thruster 10 can be a fast impulse thruster mounted to a projectile, e.g., a hyper velocity projectile, for use in modifying the projectile's trajectory. Or, in other exemplary embodiments, the thruster 10 can be a fast impulse thruster utilized for controlling microsatellite position.

Generally, the thruster 10 comprises a body 14 that includes at least one sidewall 18 and bottom wall 22 that define a propellant chamber 26 having a closed repulsion end 30 and an opposing open exhaust end 34. It is envisioned that a lateral cross-section of the thruster 10 (a longitudinal cross-section is shown in FIG. 1A) can have any desirable shape. That is, in various implementations the lateral cross-section can have circular or ovular shape such that the there is a single continuous sidewall 18 that defines the propellant chamber 26. Or, in various other implementations the lateral cross-section can have a square, rectangular, triangular, or any other polygonal shape such that the thruster body 14 includes a plurality of connected sidewalls 18 that define the propellant chamber 26.

In various embodiments, the nanothermite propellant is configured within the propellant chamber 26 to have a selected density that influences reaction propagation behavior, or rate, of the nanothermite propellant. More particularly, based on the formulation of the nanothermite propellant, the nanothermite propellant is configured within the propellant chamber 26 to have a particular selected density such that upon reaction of the nanothermite, i.e., activation of the thruster 10, the impulse generated by the thruster will have a particular selected, or desired, one of at least two distinctly different force-time profiles. Put another way, in order to achieve a thrust impulse that will have a particular selected, or desired, one of the at least two distinctly different force-time profiles, the nanothermite is configured within the propellant chamber 26 to have a particular density that has been predetermined to cause the selected nanothermite formulation to react at a rate that will generate the selected one of the at least two distinctly different characteristics.

Nanothermites can have approximately the same reaction propagation rates as certain contemporary explosives such as lead azide (PbN₃) or silver azide (AgN₃), e.g., 1500-2200 m/s. However, nanothermites do not detonate, as do contemporary explosives. Rather, nanothermite reactions are fast self-propagating oxidation-reduction reactions. Additionally, the reaction products of nanothermites are metallic and metallic oxide compounds, which are in solid phase at ambient conditions. Therefore, the pressure, or force, produced during the reaction, i.e., generation of gaseous reaction products, is much lower for nanothermites than for contemporary explosives. Hence, the nanothermite reaction can have approximately the same propagation rate as contemporary explosives, but will not damage the structure surrounding and/or housing of the nanothermite, e.g., the thruster 10, in which the nanothermite is disposed.

Different formulations of the nanothermite will exhibit different reaction propagation rates, which affect the resulting force-time profile of the thrust impulse. For example, the slower the reaction propagation rate of a particular nanothermite formulation, the greater the total duration the reaction will be. While conversely, the faster the reaction propagation rate of a particular nanothermite formulation, the shorter the total reaction duration will be. Additionally, as described in detail below, the density of a particular nanothermite material can affect the reaction propagation rate of the nanothermite and the resulting force-time profile thrust impulse.

More particularly, two different thrust modes can be created using a single nanothermite formulation. By controlling the density of the nanothermite in the propellant chamber 26, the reaction propagation behavior of the nanothermite can be controlled i.e., reaction propagation rate can be either subsonic or supersonic. When the reaction propagation rate is supersonic the thrust impulse is relatively short in duration and large in amplitude. When the reaction propagation is subsonic the thrust impulse is relatively long in duration and low in amplitude. The same nanothermite formulation can be configured within the propellant chamber 26 such that either behavior can be achieved. In order to be able to achieve two different reaction regimes with a nanothermite formulation, the formulation should be capable of exhibiting supersonic reaction propagation at low density and subsonic reaction propagation at high density.

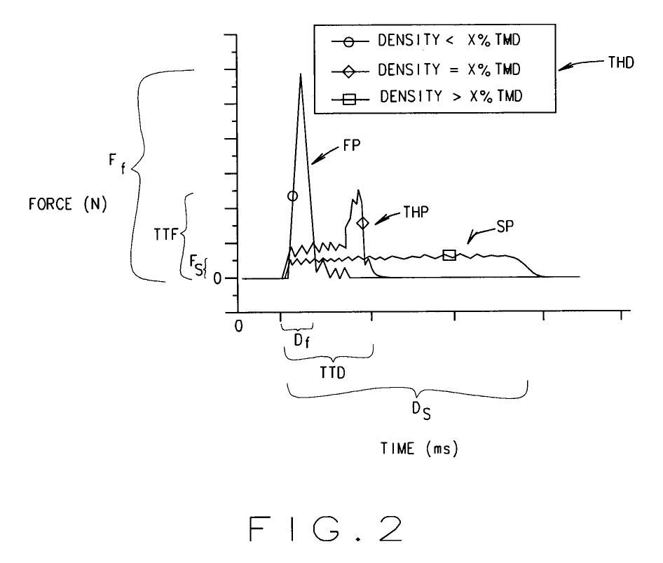

Still more particularly, as exemplarily illustrated in FIG. 2, there is a respective threshold, or transition, density THD at which the reaction propagation behavior of the nanothermite will transition between a slow regime (subsonic reaction propagation), wherein the thrust impulse will have slow force-time profile SP, and a fast regime (supersonic reaction propagation), wherein the thrust impulse will have a fast force-time profile FP. Hence, combustion of the nanothermite configured at the threshold density THD will result in a reaction propagation behavior that can transition between slow and fast regimes.

Moreover, a nanothermite configured within the propellant chamber 26 at a density suitably greater than the threshold density THD of the respective nanothermite will result in a thrust impulse having a slow force-time profile SP. Conversely, a nanothermite configured within the propellant chamber 26 at a density suitably lesser than the threshold density THD of the respective nanothermite will result in a thrust impulse having a fast force-time profile FP.

As illustrated in FIG. 2, each slow force-time profile SP comprises a thrust duration component Dₛ, e.g., time in milliseconds (ms), and a thrust force component Fₛ, e.g., force in Newtons (N). Similarly, each fast force-time profile FP comprises a thrust duration component D_{f} and a thrust force component F_{f}. As can be seen in FIG. 2, the slow thrust duration Dₛ is greater than fast thrust duration D_{f}, while the slow thrust force Fₛ is less than fast thrust force F_{f}.

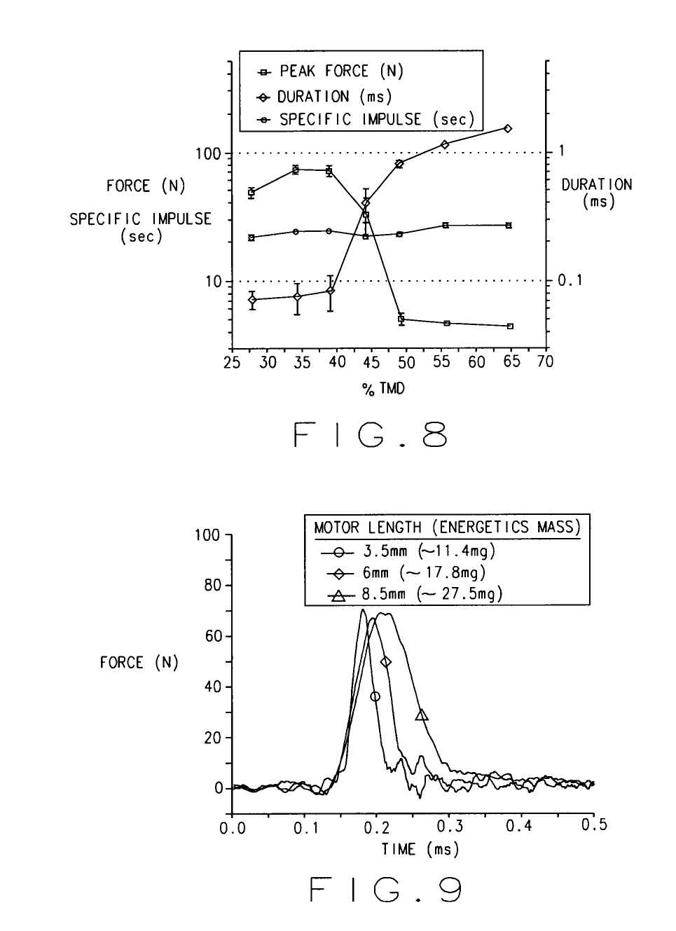

It should be understood that the reaction propagation behavior at the threshold density THD for each respective nanothermite is unstable. That is, the threshold thrust duration TTD and threshold thrust force TTF for each respective threshold density THD may vary from one thrust impulse to another for a given nanothermite configured at the threshold density THD. Hence, as shown in FIG. 8, the threshold thrust duration TTD and the threshold thrust force TTF of a given nanothermite configured at the threshold density THD may vary based on the point at which the empirical testing shows that the various combustion reactions transition from the slow to the fast reaction regime. Accordingly, it should be understood that the threshold thrust duration TTD and the threshold thrust force TTF for any given nanothermite, as described herein, are not specific values, but rather threshold thrust duration TTD and threshold thrust force TTF regions.

Importantly, the nanothermite can be configured within the propellant chamber 26 to have a particular selected density above or below the THD that will dictate, e.g., mandate, control, govern or cause, the reaction propagation behavior of the respective nanothermite such that the thrust impulse will have one of the slow force-time profile SP or the fast force-time profile FP. Specifically, if the nanothermite is configured within the thruster 10 to have a density that is greater than the threshold density THD, the thruster 10 will be configured to have a slow force-time profile SP, wherein combustion of the nanothermite will produce a reaction having a thrust duration Dₛ that is greater than the threshold thrust duration TTD region and a thrust force Fₛ that is less than the threshold thrust force TTF region. Conversely, if the nanothermite is configured within the thruster 10 to have a density that is less than the threshold density THD, the thruster 10 will be configured to have a fast force-time profile FP, wherein combustion of the nanothermite will produce a reaction having a thrust duration D_{f} that is less than the threshold thrust duration TTD region and a thrust force F_{f} that is greater than the threshold thrust force TTF region.

The force-time profile of the nanothermite at the threshold density is identified in FIG. 2 as THP. Also, nanothermite densities are calculated and described herein, and illustrated throughout the various figures as a percentage of the theoretical maximum density (TMD) of the respective nanothermite.

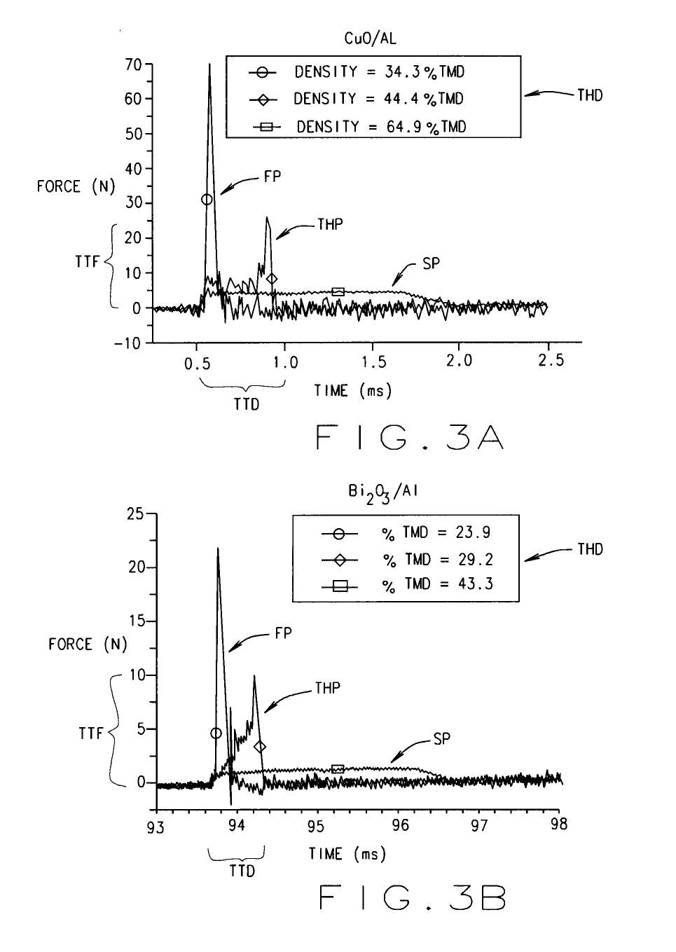

It should be further understood that the threshold density THD and the corresponding threshold thrust duration TTD region and threshold thrust force TTF region at which this change occurs can be different for different nanothermite materials. For example, as exemplarily shown in FIG. 3A, if the nanothermite material is copper oxide and aluminum (CuO/Al), wherein the threshold density THD has been empirically determined to be approximately 44.4% TMD, when the CuO/Al nanothermite is configured within the propellant chamber 26 to have a density that is less than the threshold density THD, e.g., approximately 34.3% TMD, the thruster 10 will be configured to have a fast force-time profile FP. And, when the CuO/Al nanothermite is configured within the propellant chamber 26 to have a density that is greater than the threshold density THD, e.g., approximately 64.9% TMD, the thruster 10 will be configured to have a slow force-time profile SP.

Similarly, as exemplarily shown in FIG. 3B, if the nanothermite material is bismuth oxide and aluminum (Bi₂O₃/Al), wherein the threshold density THD has been empirically determined to be approximately 29.2% TMD, when the Bi₂O₃/Al nanothermite is configured within the propellant chamber 26 to have a density that is less than the threshold density THD, e.g., approximately 23.9% TMD, the thruster 10 will be configured to have a fast force-time profile FP. And, when the Bi₂O₃/Al nanothermite is configured within the propellant chamber 26 to have a density that is greater than the threshold density THD, e.g., approximately 43.3% TMD, the thruster 10 will be configured to have a slow force-time profile SP.

Although FIGS. 3A and 3B show specific density values for the respective slow and fast force-time profiles SP and FP, it should be understood that the slow force-time profile SP for each respective nanothermite formulation is substantially constant for all nanothermite densities above the threshold density THD and the fast force-time profile for each respective nanothermite formulation is substantially constant for all nanothermite densities below the threshold density. That is, for all nanothermite densities of a given nanothermite that are above the respective threshold density THD, the resulting thrust produced will have substantially the same slow force-time profile SP that comprises substantially the same thrust duration component Dₛ and substantially the same thrust force component Fₛ. Likewise, for all nanothermite densities of a given nanothermite that are below the respective threshold density THD, the resulting thrust produced will have substantially the same fast force-time profile FP that comprises substantially the same thrust duration component D_{f} and substantially the same thrust force component F_{f}.

Additionally, although CuO/Al and Bi₂O₃/Al nanothermite formulations have been illustrated, the teachings herein are applicable to generally any suitable nanothermite formulation as will be understood by person having ordinary skill in the art. Generally, the nanothermite propellant disposed within the propellant chamber 26 comprises an oxidizer (metal oxide, non-metallic oxidizer) and fuel formulation selected to have a reaction propagation rate that will generate a thrust impulse with a desired preselected force-time profile, i.e., the slow force-time profile SP when configured to a density above the threshold density, or the fast force-time profile FP when configured to a density below the threshold density THD. For example, metal-oxides can include CuO, Bi₂O₃, MoO₃, WO₂, WO₃, Fe₂O₃, MnO₂, and TiO₂, and other oxidizers can include perchlorates, nitrates, and permanganates. Fuels can include Al, Si, B, Mg, Ta, Ti, and Zr.

Additionally, in various embodiments, the nanothermite can be formulated using one or more polymer additives (energetic binders, non-energetic binders) or high-explosive additives. For example, polymer additives can include fluoropolymers such as Teflon, tetrafluoroethylene, hexafluoropropylene and vinylidene fluoride (THV), Viton A, energetic binders such as glycidyl azide polymer (GAP), or organic polymers such as (acrylamidomethyl) cellulose acetate butyrate (AAMCAB) or nitrocellulose, and high explosive additives can include, but are not limited to cyclotrimethylenetrinitramine (RDX), pentaerythritol tetranitrate (PETN), or ammonium nitrate.

Other factors that can influence the thrust duration and thrust force include a diameter D and/or a length L of the propellant chamber 26 (shown in FIGS. 1A and 1B), the material from which the body 14 is fabricated. Such factors can affect energy losses and hence, can affect the value of the threshold density THD.

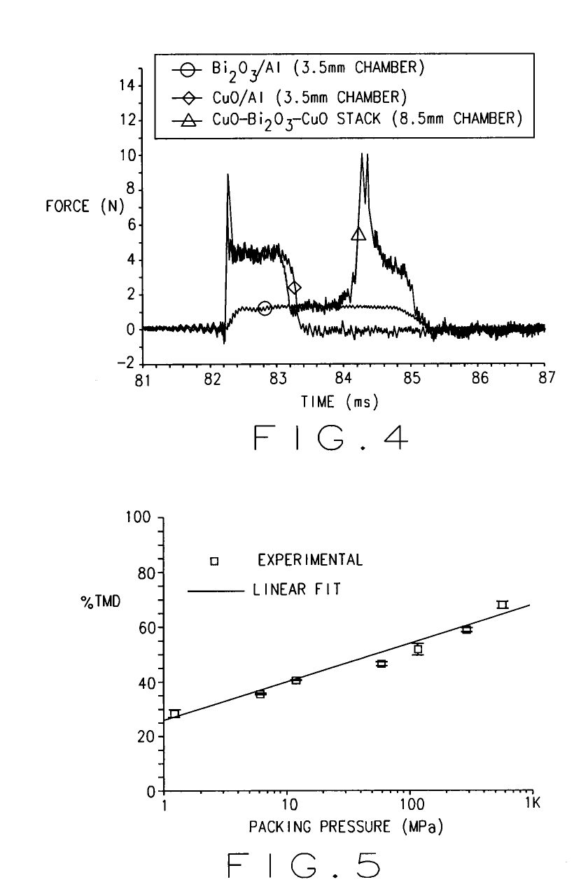

Referring now to FIG. 4, in various embodiments, the thruster 10 can be loaded with a plurality of layers of nanothermite propellant configured within the propellant chamber 26 to dictate the reaction regime of each respective layer, i.e., either the fast or slow reaction regime, thereby providing the thruster with a dynamically changing force-time profile. FIG. 4 illustrates separate force-time profiles resulting from the thruster 10 being configured with a single layer of Bi₂O₃/Al to density of X % TMD; a single layer of CuO/Al to a density of Y % TMD; and a multi-layer stack comprising a layer of CuO/Al configured at Y % TMD, a layer of Bi₂O₃/Al configured at X % TMD and another layer of CuO/Al configured at X % TMD. Accordingly, the reaction propagation rate of each respective layer will produce thrust force with selected thrust force components Fₛ and F_{f}. Thus, as each layer reacts, the thrust force will change providing a dynamically changing force-time profile.

As illustrated in FIG. 4, the thrust force produced by each respective layer is independent of the layer configuration, and is substantially the same as the thrust force would be if the thruster 10 was fully loaded with a single layer of the respective nanothermite material configured to the same respective density.

In such layered embodiments, each respective layer can comprise one or more layers of the same nanothermite (i.e., the same oxidizer and fuel formulation) configured at the same or different densities, wherein each layer has a different density than each adjacent layer. Or, one or more of the layers can comprise different nanothermites (i.e., different oxidizer and fuel formulations), wherein each layer has a respective density that may or may not be the same as adjacent layers.

Referring again to FIGS. 1A and 1B, as described above, the size and shape of the propellant chamber 26 can affect the ejection of the reaction products, and hence the force-time profile of the impulse from the thruster 10. Additionally, the presence or absence of obstructions or impediments of the exhaust material as the nanothermite reaction occurs can influence the duration and force components of the resulting force-time profile.

For example, in various embodiments exemplarily illustrated in FIG. 1A, the thruster 10 can be structured such that the propellant chamber 26 has a substantially constant diameter D throughout the entire length L, whereby the open exhaust end 34 has a diameter that is substantially equal to the diameter D of the remainder of the propellant chamber 26. Therefore, the flow of reaction exhaust gases from the propellant chamber 26, upon reaction of the nanothermite propellant, will be unimpeded. And, hence the force-time profile, i.e., the thrust duration and the thrust force, will be unaffected.

Alternatively, in various other embodiments exemplarily illustrated in FIG. 1B, the open end 34 of the thruster 10 can be structured to form a convergent-divergent nozzle 38 extending from the propellant chamber 26. The convergent-divergent nozzle 38 includes a convergent portion 38A and a divergent portion 38B. The convergent portion 38A extends from the propellant chamber 26 and is tapered radially inward such that the open end 34 is narrowed from the diameter D of the propellant chamber 26 to a smaller diameter d. The divergent portion 38B extends from the convergent portion 38A and is tapered radially outward such that the open end 34 is expanded from the diameter d of the convergent portion 38A to a smaller diameter D₂ that may or may not be equal to the propellant chamber diameter D. As one skilled in the art will readily recognize, the convergent portion 38A will modify, e.g., impede or restrict, the flow of reaction products from the propellant chamber 26 such that the resulting force-time profile, i.e., the thrust duration and/or the thrust force, will be affected by the convergent-divergent nozzle 38.

### Example

This example describes the analysis of the combustion reaction of a thruster, such as thruster 10, utilizing a CuO/Al nanothermite propellant and the methods of controlling the force-time profile thereof, in accordance with the various embodiments of the present disclosure, as set forth above.

### Nanothermite Preparation

The nanothermite composition used to obtain the following exemplary results consisted of CuO nanorods and Al nanoparticles.

### Thruster Design

The various thrusters used to obtain the following exemplary results were fabricated by boring out stainless steel bolts. The inner diameter of each propellant chamber was 1/16 in. (1.59 mm). Three thrusters were fabricated, one having a propellant chamber length of 3.5 mm, another having a propellant chamber length of 6 mm, and the third having a propellant chamber length of 8.5 mm. Two of the thrusters were fabricated without a nozzle, such as thruster 10 shown in FIG. 1A, and the third thruster was fabricated with a convergent-divergent nozzle, such as thruster 10 shown in FIG. 1B.

The fabrication was carried out using a precision lathe. The diameter of the propellant chambers was defined by the diameter of the drill bit used for boring out the propellant chambers. The thrusters with no nozzle were fabricated by drilling in a set depth from one side, and then bottoming out the bottom wall of the propellant chamber. The thruster with the convergent-divergent nozzle was fabricated by boring in from both sides. In this example, the propellant chamber and convergence of the nozzle was bored out from one direction using a drill bit with a 60° taper. Then the divergence of the nozzle was created by drilling from the opposite direction using a drill bit with a 30° taper. This fabrication method resulted in the chamber being open at the bottom. The bottom wall was formed by sealing the open bottom with a threaded plug coated with epoxy.

The CuO/Al nanothermite propellant was disposed within the propellant chamber and compacted using a hydraulic press. This allowed precise packing of the nanothermite propellant to a selected packing pressure. The material was loaded incrementally in 2-3 mg iterations (estimated from total loaded mass and number of loading iterations) and pressed each time. This ensured uniform uniform density of the loaded nanothermite propellant. The nanothermite propellant was loaded until the chamber was completely filled. Therefore, at higher selected densities, more nanothermite propellant was loaded into the propellant chamber. Seven different packing pressures were tested from 1.26 MPa (˜183 psi) up to 630 MPa (˜91,000 psi) using the thruster with 3.5 mm length propellant chamber and no nozzle. The resulting percentage of TMD for this range of pressures was 28.0% to 64.9%. The percentage of TMD was calculated based on an estimated TMD of 5.36 g/cc for the present CuO/Al nanothermite mixture.

In addition to comparing the effect of different densities, the three different lengths of chamber were tested, and the motor with a convergent-divergent nozzle was compared to the thruster with no nozzle. The thruster with no nozzle was loaded through the top, and the thruster with the convergent-divergent nozzle was loaded through the bottom, and then sealed using the plug, as described above. All of the different thrusters with and without the convergent-divergent nozzle were tested at both high packing pressure (315 MPa) and low packing pressure (6.3 MPa). The thrusters were weighted in between each test to verify that there was no loss in mass, i.e., erosion of the propellant chamber or the nozzle. Therefore, the motors could be reused to complete a series of tests. Every experimental condition was tested four times to obtain an average. A list of experiments performed and the variables is shown in Table 1 below.

TABLE 1
List of experimental conditions and variables tested.

| | Pressure | Length | |
|---|---|---|---|
| Packing | Chamber (MPa) | (mm) | Nozzle Design |
| Variable (1.26-630) | | 3.5 | No Nozzle |
| | 6.30 | Variable (3.5, 6.0, 8.5) | No Nozzle |
| | 315.00 | Variable (3.5, 6.0, 8.5) | No Nozzle |
| | 6.30 | 6.0 | Convergent- |
| | | | Divergent |
| | 315.00 | 6.0 | Convergent- |
| | | | Divergent |

Ignition of the nanothermite propellant was triggered using a fuse-wire coated with the nanothermite composite. The fuse-wire was not in physical contact with the thruster, but it was within 2 mm to allow the reaction to jump from the fuse-wire to the material within the propellant chamber. The exhaust plume was recorded with a high-speed camera. The fuse-wire ignition, force sensor DAQ, and camera recording were triggered synchronously using a DC battery and a push-button switch. The force sensor was plugged into a charge amplifier, and the amplifier output signal was sent to a data acquisition (DAQ) board.

### Effect of Density

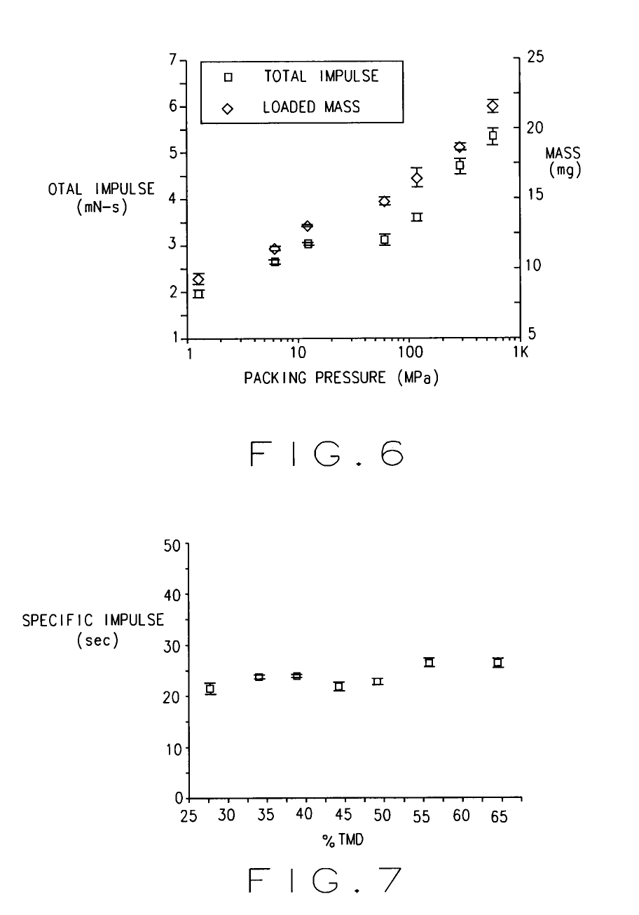

The percentage of TMD versus packing pressure is shown in FIG. 5. An approximately linear relationship between the Logarithm of packing pressure and percentage of TMD is expected for cold-pressing of powders. Since the volume of the propellant chamber was constant in this series of tests, the mass of the nanothermite propellant varied directly with the density. The total impulse and mass versus packing pressure are shown in FIG. 6. The total impulse varied similarly to the mass, which indicates the thrust efficiency was almost constant.

The thrust efficiency is measured by the specific impulse (I_{SP}) defined by equation (1)

I_{SP}=(∫F·dt)/W_{P} (1)

where, F is the measured thrust force, and W_{P} is the nanothermite propellant weight. As shown in FIG. 8, there did not appear to be any discernable correlation between the specific impulse and percentage of TMD. When the pressing density was varied, two distinct reaction regimes were observed.

It can be seen from FIG. 8 that the peak thrust and duration change by more than one order of magnitude when the reaction propagation crosses from one regime to the other, i.e., from the fast regime to the slow regime. For the CuO/Al nanothermite propellant configured at low densities (e.g., less than 44.4% TMD) the propellant had a very fast reaction propagation rate, i.e., the reaction thrust duration was less than 50 μsec and the resulting reaction thrust force was greater than 40N. Conversely, at high densities (e.g., greater than 44.4% TMD) the propellant had very slow reaction propagation rate, and the resulting thrust force was much lower (e.g., 4-5 N).

More particularly, as the density was varied from 28.0% TMD to 64.9% TMD, the transition between the slow and fast regimes was not gradual. Specifically, at 44.4% TMD, the transition between the fast and slow combustion reaction regimes was observed. FIG. 3A exemplarily illustrates the reaction thrust forces for the fast regime (i.e., <44.4% TMD) and the slow regimes (i.e., >44.4% TMD).

The threshold density at which the transition occurs is related to the properties of the nanothermite propellant, such as particle size and fuel and oxidizer formulation of the propellant. Additionally, in a small-scale system, such as the present thruster, there will likely be external effects that influence the threshold density. For example, the diameter and wall material of the propellant chamber can affect energy losses, and hence affect the threshold density at which reaction regime transition occurs.

### Effect of Thruster Length

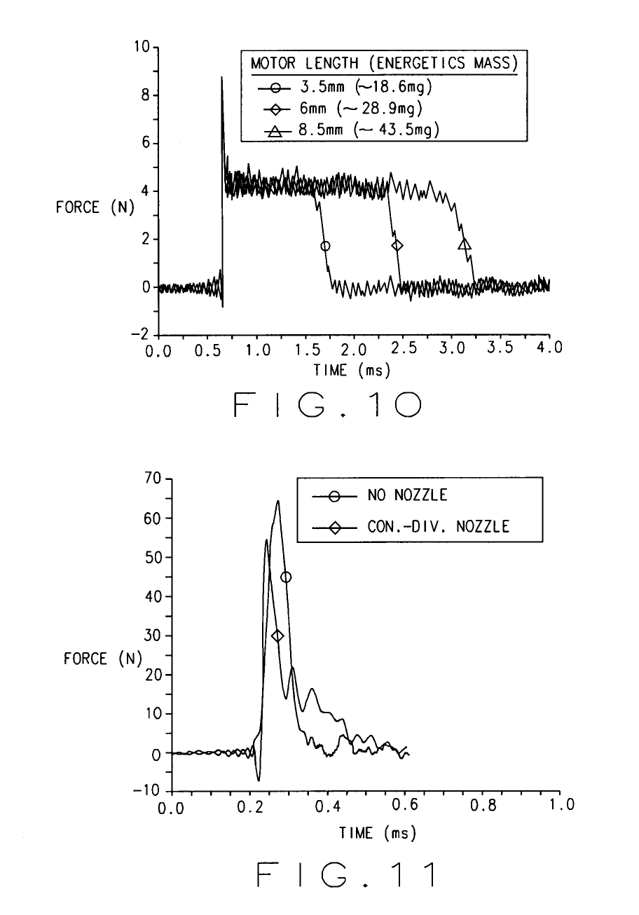

The effect of thruster length was tested in each of the fast and slow regimes. The low density regime, i.e., the fast reaction regime, was tested at 34.3% TMD and the high density regime, i.e., the slow reaction regime, was tested at 56.0% TMD. FIG. 9 shows the force-time profile for each thruster in the low density regime, and FIG. 10 shows the force-time profiles for the high density regime. Each of the profiles shown in FIGS. 9 and 10 is a point-by-point average of profiles from four independent tests. As illustrated in FIGS. 9 and 10, the duration of the reaction thrust increases almost linearly with the increased length of the propellant chamber, indicating that the reaction propagation rate is nearly constant regardless of the density. The initial spike in the force-time profiles illustrated in FIG. 10 is from the reaction of the nanothermite coating on the fuse-wire.

### Nozzle Design Effect

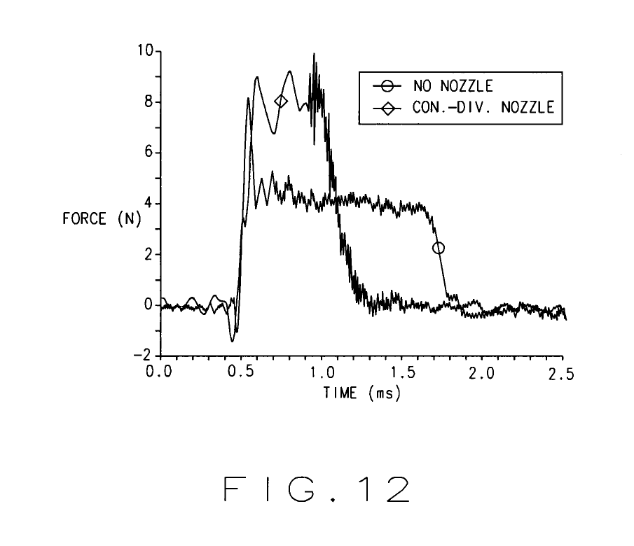

The convergent-divergent nozzle design shown in FIG. 1B was tested for comparison with the thruster without a nozzle shown in FIG. 1A. The comparison was performed in both the fast regime (i.e., at 34.3% TMD) and the slow regime (i.e., at 56.0% TMD). The force-time profile for the convergent-divergent nozzle compared with force-time profile for the no nozzle design in the fast combustion reaction regime is shown in FIG. 11. The force-time profile for the convergent-divergent nozzle compared with the force-time profile for the no nozzle design in the slow combustion reaction regime is shown in FIG. 12.

As illustrated FIG. 11, in the fast reaction regime, the convergent-divergent nozzle reduces the amplitude of the thrust force from 65 N to 54 N, and increases the thrust duration from 55.0 μs to 83.4 μs (full width at half height (FWHM)). Additionally, in the fast reaction regime, the specific impulse changes from 24.81±0.41 sec to 26.68±0.82 sec. As illustrated in FIG. 12, in the slow reaction regime, the convergent-divergent nozzle increases the amplitude of the thrust force from 4.2 N to 8 N and reduces the thrust duration from 1.22 ms to 0.55 ms (FWHM), and the specific impulse changes from 28.27±0.95 sec to 24.82±0.79 sec.

Based on the force-time profiles illustrated in FIGS. 11 and 12, in various embodiments, regardless of the nanothermite propellant used and the respective density, if reactions within the slow regime are desired, using a thruster with the convergent-divergent nozzle is generally more suitable. However, if reactions within the fast regime are desired, using a thruster without the convergent-divergent nozzle is generally more suitable.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A thruster, said thruster comprising:
a body comprising at least one sidewall and a bottom wall that define a propellant chamber having a closed repulsion end and an opposing open exhaust end; and
a nanothermite propellant configured within the propellant chamber to have a selected density that dictates a reaction propagation rate of the nanothermite propellant such that a thrust impulse of the thruster will have a selected one of two distinctly different force-time profiles.

2. The thruster of claim 1, wherein the nanothermite propellant density is selected to be one of above or below a threshold density at which the reaction propagation rate of the nanothermite propellant changes between a subsonic characteristic and a supersonic characteristic such that the reaction propagation rate of the nanothermite propellant is selected to produce the thrust impulse having one of a slow force-time profile or a fast force-time profile based on whether the nanothermite density is selected to be above or below the threshold density.

3. The thruster of claim 2, wherein the slow force-time profile comprises a thrust duration component (Dₛ) and a thrust force component (Fₛ), and the fast force-time profile comprises a thrust duration component (D_{f}) and a thrust force component (F_{f}), wherein Dₛ is greater than D_{f} and Fₛ is less than F_{f}.

4. The thruster of claim 2, wherein the nanothermite propellant comprises an oxidizer and fuel formulation selected to have a reaction propagation rate that will generate the thrust impulse with the preselected slow force-time profile when configured to a density above the threshold density, or the preselected fast force-time profile when configured to a density below the threshold density.

5. The thruster of claim 4, wherein the nanothermite propellant formulation comprises one of CuO/Al and Bi₂O₃/Al.

6. The thruster of claim 4, wherein the nanothermite propellant formulation comprises:
an oxidizer component including one of:
a metal oxide selected from the group consisting of CuO, Bi₂O₃, MoO₃, WO₂, WO₃, Fe₂O₃, MnO₂, TiO₂; and
a non-metallic oxidizer selected from the group consisting of perchlorates, nitrates and permanganates; and
a fuel component selected from the group consisting of Al, Si, B, Mg, Ta, Ti and Zr.

7. The thruster of claim 4, wherein the nanothermite propellant formulation further comprises one or more polymer additives including at least one of:
a fluoropolymer selected from the group of Teflon, THV, Viton A;
an energetic binder selected from the group of glycidyl azide polymer (GAP); and
an organic polymer selected from the group of AAMCAB or nitrocellulose.

8. The thruster of claim 4, wherein the nanothermite propellant formulation further comprises a high-explosive additive comprising at least one of RDX, PETN and ammonium nitrate.

9. The thruster of claim 1 further comprising a plurality of layers of nanothermite propellant disposed within the propellant chamber, each layer being configured within the propellant chamber to have a respective selected density such that the reaction propagation rate of the respective layer will generated a respective thrust impulse having a selected slow or fast force-time profile, thereby providing the thruster with a dynamically changing thrust impulse force-time profile.

10. The thruster of claim 9, wherein at least one of the layers of nanothermite propellant comprises a different oxidizer and fuel formulation than at least one other layer of nanothermite propellant.

11. The thruster of claim 1, wherein the propellant chamber is structured to have a substantially constant diameter throughout an entire length of the propellant chamber, whereby the open exhaust end has a diameter that is substantially equal to the diameter of the remainder of the propellant chamber such that at least one of a reaction thrust force and a reaction duration generated by combustion of the nanothermite propellant will be unaffected by the open exhaust end.

12. The thruster of claim 1 wherein the open end of the thruster is structured to form a convergent-divergent nozzle extending from the propellant chamber, whereby a flow of reaction products from the propellant chamber, generated upon combustion of the nanothermite propellant, will be modified such that the resulting force-time profile will be affected by convergent-divergent nozzle.

13. A method for selectably controlling a force-time profile of a thruster impulse, said method comprising:
disposing a nanothermite propellant within a propellant chamber of a body of a thruster, wherein the body comprises at least one sidewall and a bottom wall that define the propellant chamber having a closed repulsion end and an opposing open exhaust end; and
configuring the nanothermite propellant within the propellant chamber to have a density selected to be either above or below a threshold density at which the reaction propagation rate of the nanothermite propellant changes between a subsonic characteristic and a supersonic characteristic such that the reaction propagation rate of the nanothermite propellant is selected to generate a thrust impulse with one of a slow force-time profile or a fast force-time profile based on whether the nanothermite density is selected to be above or below the threshold density.

14. The method of claim 13, wherein configuring the nanothermite propellant comprises configuring the nanothermite propellant within the propellant chamber at the selected density above or below the threshold density, wherein the thrust impulse slow force-time profile comprises a thrust duration component (Dₛ) and a thrust force component (Fₛ), and the thrust impulse fast force-time profile comprises a thrust duration component (D_{f}) and a thrust force component (F_{f}), wherein Dₛ is greater than D_{f} and Fₛ is less than F_{f}.

15. The method of claim 13, wherein configuring the nanothermite propellant comprises selecting the nanothermite propellant to have an oxidizer and fuel formulation that will produce a selectively predetermined reaction propagation rate that will generate the thrust impulse with the slow force-time profile when configured to a density above the threshold density, or the thrust impulse with the fast force-time profile when configured to a density below the threshold density.

16. The method of claim 15, wherein selecting the nanothermite propellant comprises selecting the nanothermite propellant formulation to comprise one of CuO/Al and Bi₂O₃/Al.

17. The method of claim 15, wherein selecting the nanothermite propellant comprises selecting the nanothermite propellant formulation to comprise:
an oxidizer component including one of:
a metal oxide selected from the group consisting of CuO, Bi₂O₃, MoO₃, WO₂, WO₃, Fe₂O₃, MnO₂, TiO₂; and
a non-metallic oxidizer selected from the group consisting of perchlorates, nitrates and permanganates; and
a fuel component selected from the group consisting of Al, Si, B, Mg, Ta, Ti and Zr.

18. The method of claim 13 further comprising configuring a plurality of layers nanothermite propellant within the propellant chamber such that each layer is configured within the propellant chamber to have a respective selected density such that the reaction propagation rate of the respective layer will generated a respective thrust impulse having a selected slow or fast force-time profile, thereby providing the thruster with a dynamically changing thrust impulse force-time profile.

19. The method of claim 13 further comprising utilizing a thruster wherein the propellant chamber is structured to have a substantially constant diameter throughout an entire length of the propellant chamber, whereby the open exhaust end has a diameter that is substantially equal to the diameter of the remainder of the propellant chamber such that at least one of a thrust force and a thrust duration generated by combustion of the nanothermite propellant will be unaffected by the open exhaust end.

20. A thruster that utilizes a nanothermite material as a propellant, said thruster comprising:
a body comprising at least one sidewall and a bottom wall that define a propellant chamber having a closed repulsion end and an opposing open exhaust end;
a nanothermite propellant configured within the propellant chamber to have a density selected to be either above or below a threshold density at which the reaction propagation rate of the nanothermite propellant changes between a subsonic characteristic and a supersonic characteristic such that the reaction propagation rate of the nanothermite propellant is selected to generated a thrust impulse with one of a slow force-time profile or a fast force-time profile based on whether the nanothermite density is selected to be above or below the threshold density, wherein the slow force-time profile comprises a thrust duration component (Dₛ) and a thrust force component (Fₛ), and wherein the fast force-time profile comprises a thrust duration component (D_{f}) and a thrust force component (F_{f}), and further wherein Dₛ is greater than D_{f} and Fₛ is less than F_{f}.

21. The thruster of claim 20, wherein the nanothermite propellant comprises an oxidizer and fuel formulation selected to have a reaction propagation rate that will generate the thrust impulse with the slow force-time profile when configured to a density above the threshold density, or the fast force-time profile when configured to a density below the threshold density.

22. The thruster of claim 20 further comprising a plurality of layers of nanothermite propellant disposed within the propellant chamber, each layer being configured within the propellant chamber to have a respective selected density such that the reaction propagation rate of the respective layer will generate a respective thrust impulse having a respective selected slow or fast force-time profile, thereby providing the thruster with a dynamically changing thrust impulse force-time profile.

23. The thruster of claim 22, wherein at least one of the layers of nanothermite propellant comprises a different oxidizer and fuel formulation than at least one other layer of nanothermite propellant.

24. The thruster of claim 20, wherein the propellant chamber is structured to have a substantially constant diameter throughout an entire length of the propellant chamber, whereby the open exhaust end has a diameter that is substantially equal to the diameter of the remainder of the propellant chamber such that at least one of a thrust force and a thrust duration generated by combustion of the nanothermite propellant will be unaffected by the open exhaust end.
